(19) United States
(12) Patent Application Publication
(10) Pub. No.: US 2016/0342457 A1
(43) Pub. Date: Nov. 24, 2016

(54) PROCESSING A REQUEST FOR A WEB RESOURCE

(71) Applicant: YANDEX EUROPE AG, Luzern (CH)

(72) Inventors: Roman Kirillovitch IVANOV, Moscow (RU); Aleksandr Aleksandrovich PONOMARENKO, Novosibirsk, Novosibirsk region (RU)

(21) Appl. No.: 15/107,169

(22) PCT Filed: Aug. 1, 2014
(86) PCT No.: PCT/IB14/63635

§ 371 Date: Jun. 22, 2016

(30) Foreign Application Priority Data
Jan. 31, 2014 (RU) 2014103705

(51) Int. Cl. G06F 11/07; H04L 12/26

(52) U.S. Cl. CPC G06F 11/0769; G06F 11/0772; G06F 11/0709; H04L 43/0823

(57) ABSTRACT

There is disclosed a method of processing a user request for an access to a web resource, the method executable at an electronic device. The method comprises receiving, by a browsing application of the electronic device, a user request for access to the web resource; obtaining, via a communication network, information about the web resource; in response to the information being representative of an error accessing the web resource, causing simultaneous display in the browsing application: (i) in a first portion of the browser, a first error resolution field provided by the network resource being accessed, and (ii) in a second portion of the browser, a second error resolution field provided by an entity other than the network resource being accessed.

### CROSS-REFERENCE

The present application claims convention priority to Russian Patent Application No. 2014103705, filed Jan. 31, 2014, entitled “A SYSTEM AND METHOD FOR PROCESSING A USER REQUEST FOR AN ACCESS TO A WEB RESOURCE” which is incorporated by reference herein in its entirety.

### FIELD

The present technology relates to web browsers in general and specifically to a system and method for processing a user request for an access to a web resource.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

For example, the given user may be interested in viewing pictures of Britney Spears, but may not be aware of a particular resource that would present such information. Alternatively, the given user may be interested in locating the closest Starbucks coffee shop, but again may not be aware of a particular web resource to provide such location services. In these fictitious (yet practical) circumstances, the given user may run a web search using a search engine.

The web resources are hosted on various servers or other network devices. Typically, operators of the web resources spend significant resources (both time and money) to maintain the servers and the web resources in good working order, so that users trying to access the web resource can easily do so. This is particularly important for those resources that operate a web-based commercial enterprise, such as for example an on-line store selling various goods or services. Quite clearly, in order to generate revenue, such a web resource needs to be available to the users trying to access it. Same considerations apply to news portals, web mail portals and many other types of web resources.

Despite all the attempts by the administrators of the web resources to keep the web resources up and running, it does happen that a particular resource sought by a particular user becomes unavailable. There are many reasons why a particular web resource may become unavailable—such as, the server being down, too many users are trying to access the web resource at the same time and the like. Alternatively, the user may have typed the URL associated with the web resource incorrectly or the link that has been activated by the user may have been “broken” (i.e. be out-dated or otherwise misspelled).

Several error codes have been developed to manage situations where a particular web resource is not available. One example of such error codes are the Hypertext Transfer Protocol (HTTP) response status codes specifically dedicated to error situations. These codes have been developed by the Internet Engineering Task Force (IETF). Typically, the first digit of the status code specifies one of several classes of response. Typically, a HTTP client is configured to recognize at least 5 classes of errors.

For example, HTTP 404 message (also known as a “not found message” or “404 Not Found” message) is a standard response code indicating that a particular server allegedly hosting a particular web resource is not responding to communication or, in other words, indicative of the fact that a communication device used by the user to access the web resource could not communicate with the server allegedly hosting the web resource. The 404 message is also typically presented to the user when a user is attempting to follow a broken or a dead link.

A typical 404 Not Found error page is depicted with reference to FIG. 1, where a screen shot 102 depicts a known “404 Not Found error” page. The screen shot 102 depicts a browser application 104, which browser application 104 being implemented as a Mozilla Firefox browser.

The browser application 104 has a command interface 106 and the browsing interface 108. The purpose of the command interface 106 is to allow the user to type or copy-and-paste a Unified Resource Locator (URL) or, simply, an address associated with the web resource the user is looking for. The purpose of the browsing interface 108 is to show the web resource that is hosted at the address, which URL is entered into the command interface 106.

The browser application 104 further includes a browser command buttons panel 112, the browser command buttons panel 112 including a number of conventionally known fields, such as “File”, “Edit”, “View”, “History”, “Bookmarks”, “Tools”, “Help”. The browser application 104 further includes a browser control buttons panel 114, which browser control buttons panel 114 includes the well-known button for minimizing the browser screen, maximizing the browser screen and closing the browser screen (all not numbered).

The browser application 104 also includes a conventionally-known back button 116, the back button 116 for allowing the user to go back to one or more of the previously viewed web resources. The browser application 104 also includes a forward button 118 (greyed out) for going “forward” after the back button 116 has been potentially used. The browser application 104 contains a number of additional buttons 120, such as a reload button, a close button and a “home” button (all not numbered) conventionally known to those of skill in the art.

As can be seen within the illustration of the screen shot 102, the user has entered an address into the command interface 106 (http://erijheels.com/freetrademarksforstartups.com). As can also be appreciated, the browsing interface 108 has been populated with an error message 122, the error message 122 being representative of the typical “404 Not Found” message of the prior art. This error message 122 could have been a result of the requested web resource having been moved or deleted or, there otherwise being an error in the URL of the web resource being requested. Within the depicted example of the prior art implementations, the error message 122 provides information that “Not Found. The requested URL/erikjheels.com/freetrademarksforstartups.com was not found on this server. Apache/2.0.52 (Red Hat) Server at erikheels.com Port 80”.

Some operators of web resources have been known to add a custom message to be included with the “404 Not Found” error message. For example, some web resource operators have added a snippet of code to serve as a customized 404 error page. Some web resource operators have added such code to provide a link to the home page associated with the domain that hosts the non-available web resource being requested by the user, for example. Alternatively, some web resource operators (typically search engines) have provided a search interface to their customized 404 error page.

There are several other types of known errors, including a number of additional known “4xx” errors. These include, but are not limited to, 400 Bad Request (the request cannot be fulfilled due to bad syntax); 403 Forbidden (the request was a valid request, but the server is refusing to respond to it) or the 408 Request Timeout (the server timed out waiting for the request).

### SUMMARY

It is an object of the present technology to ameliorate at least some of the inconveniences present in the prior art.

According to a first broad aspect of the present technology, there is provided a method of processing a user request for an access to a web resource. The method is executable at an electronic device. The method comprises receiving, by a browsing application of the electronic device, a user request for access to the web resource; obtaining, via a communication network, information about the web resource; in response to the information being representative of an error accessing the web resource, causing simultaneous display in the browsing application: (i) in a first portion of the browser, a first error resolution field provided by the network resource being accessed, and (ii) in a second portion of the browser, a second error resolution field provided by an entity other than the network resource being accessed.

In some implementations of the method, the entity is the browsing application.

In some implementations of the method, the information about the web resource is embodied in an error message. In some implementations of the method, the method further comprising receiving, via the communications network, the error message.

In some implementations of the method, the error message further comprises information instrumental for generating the first error resolution field.

In some implementations of the method, the error message is one of a 4xx error, a5xx error, a DNS-type error and a security warning.

In some implementations of the method, the error message is a “404 Not Found” error message.

In some implementations of the method, the second error resolution field comprises information about the error.

In some implementations of the method, the second error resolution field comprises a link to another resource related to the web resource.

In some implementations of the method, the second resolution field comprises a set of links to at least two resources, the at least two resources having been generated by a link error correction routine based on analysis of errors contained in an address of the web resources entered by the user.

In some implementations of the method, the second error resolution field further comprises a link to a cached version of the web resource.

In some implementations of the method, the second error resolution field further comprises a link to a home page of a domain hosting the web resource.

In some implementations of the method, the second resolution field comprises a search field for enabling the user to execute a web search.

In some implementations of the method, the method further comprises populating a suggested search term for the search field, the suggested search term being related to the web resource.

In some implementations of the method, the method further comprises augmenting a command field of the browser application with an indication of the error.

In some implementations of the method, the method further comprises receiving from a server associated with the web resource information instrumental in generating the first error resolution field.

In some implementations of the method, the first error resolution field is generated based on a custom error message information provided by a server associated with the web resource.

According to another broad aspect of the present technology, there is provided a method of processing a user request for an access to a web resource using an electronic device. The method comprises receiving, at a server, from the electronic device via a communication network, the user request for the access to the web resource; obtaining information from the web resource; in response to the information being representative of an error accessing the web resource, causing simultaneous display in a browser application of the electronic device: (i) in a first portion of the browser, a first error resolution field provided by the network resource being accessed, and (ii) in a second portion of the browser, a second error resolution field provided by an entity other than the network resource being accessed.

According to another broad aspect of the present technology there is provided an electronic device. The electronic device comprises a user input interface; a user output interface; a network communication interface; a processor coupled to the user input interface, the user output interface and the network communication interface, the processor configured to: receive via the user input interface, a user request for access to the web resource; obtaining, via the network communication interface, information about the web resource; in response to the information being representative of an error accessing the web resource, the processor is further configured to simultaneously display via the user output interface: (i) in a first portion of the user output interface, a first error resolution field provided by the network resource being accessed, and (ii) in a second portion of the user output interface, a second error resolution field provided by an entity other than the network resource being accessed.

In some implementations of the electronic device, the entity is the processor.

In some implementations of the electronic device, the information about the web resource is embodied in an error message.

In some implementations of the electronic device, the processor is further configured to receive, via the network communication interface, the error message.

In some implementations of the electronic device, the error message further comprises information instrumental for generating the first error resolution field.

In some implementations of the electronic device, the error message is one of a 4xx error, a5xx error, a DNS-type error and a security warning.

In some implementations of the electronic device, the error message is a “404 Not Found” error message.

In some implementations of the electronic device, the second error resolution field comprises information about the error.

In some implementations of the electronic device, the second error resolution field comprises a link to another resource related to the web resource.

In some implementations of the electronic device, the second resolution field comprises a set of links to at least two resources, the at least two resources having been generated by a link error correction routine based on analysis of errors contained in an address of the web resources entered by the user.

In some implementations of the electronic device, the second error resolution field further comprises a link to a cached version of the web resource.

In some implementations of the electronic device, the second error resolution field further comprises a link to a home page of a domain hosting the web resource.

In some implementations of the electronic device, the second resolution field comprises a search field for enabling the user to execute a web search.

In some implementations of the electronic device, the processor is further configured to populate a suggested search term for the search field, the suggested search term being related to the web resource.

In some implementations of the electronic device, the user output interface executes a browsing application, and wherein the processor is further configured to augment a command field of the browser application with an indication of the error.

In some implementations of the electronic device, the processor is further configured to receive from a server associated with the web resource, via the network communication interface, information instrumental in generating the first error resolution field.

In some implementations of the electronic device, the first error resolution field is generated based on a custom error message information provided by a server associated with the web resource.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a screen shot 102 displaying a known 404 Not Found error page, the screen shot 102 being implemented in accordance with known techniques.

FIG. 2 is a schematic diagram depicting a system 200, the system 200 being implemented in accordance with non-limiting embodiments of the present technology.

FIG. 3 depicts a screen shot of a non-limiting embodiment of the browser application 204 executed on an electronic device 202 of the system 200 of FIG. 2, the browser application 204 prior to user inputting any URLs.

FIG. 4 depicts a portion of the browser application 204 of FIG. 3 executing the error management routine according to a non-limiting embodiment of the present technology.

FIG. 5 depicts a portion of the browser application 204 of FIG. 3 executing the error management routine according to another non-limiting embodiment of the present technology.

FIG. 6 depicts a flow chart of a method 600, the method implemented in accordance with embodiments of the present technology and executable within the system 200 of FIG. 2.

### DETAILED DESCRIPTION

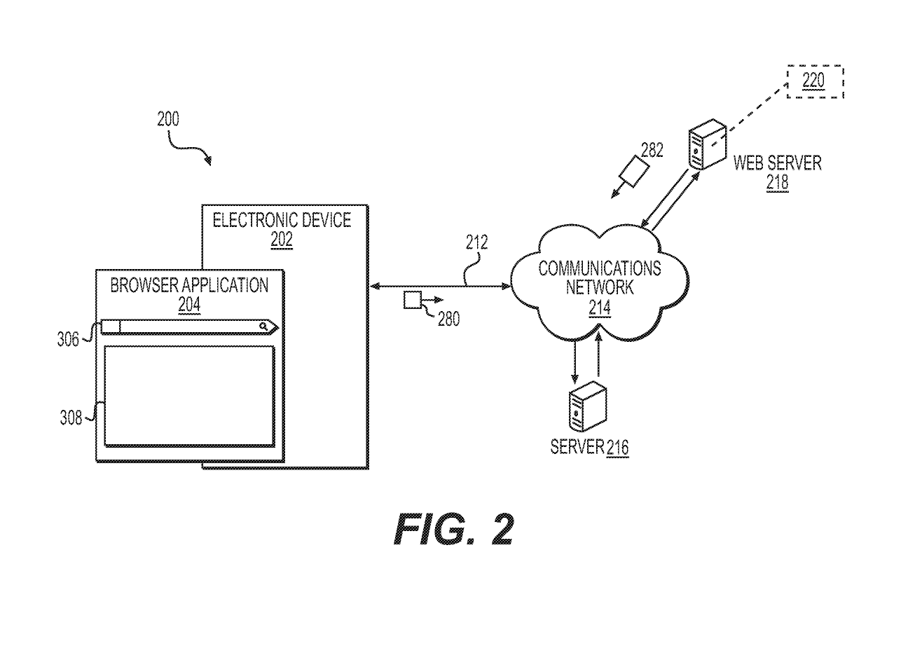

Referring to FIG. 2, there is shown a schematic diagram of a system 200, the system 200 being suitable for implementing non-limiting embodiments of the present technology. It is to be expressly understood that the system 200 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises an electronic device 202. The electronic device 202 is typically associated with a user (not depicted) and, as such, can sometimes be referred to as a “client device”. It should be noted that the fact that the electronic device 202 is associated with the user does not need to suggest or imply any mode of operation—such as a need to log in, a need to be registered or the like.

The implementation of the electronic device 202 is not particularly limited, but as an example, the electronic device 202 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 202 is known in the art and, as such, will not be described here at much length. Suffice it to say that the electronic device 202 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over the communications network 214; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The electronic device 202 comprises hardware and/or software and/or firmware (or a combination thereof), as is known in the art, to execute a browser application 204.

Generally speaking, the purpose of the browser application 204 is to enable the user (not depicted) to access one or more web resources.

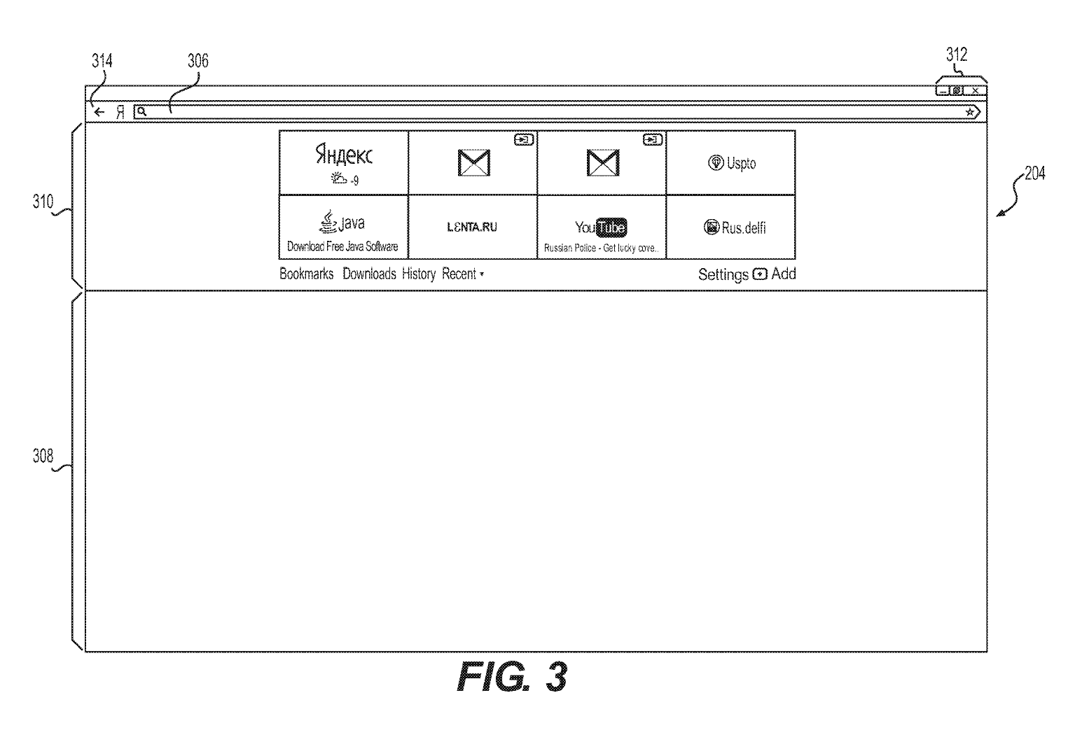

How the browser application 204 is implemented is not particularly limited. One example of the browser application 204 may be embodied as a Yandex™ browser, an example of which is depicted with reference to FIG. 3, which depicts a screen shot of a non-limiting embodiment of the browser application 204 prior to user inputting any URLs.

The browser application 204 has a command interface 306 and the browsing interface 308, both of which are empty as the user has not yet started inputting any web resource addresses. Within the illustration of FIG. 3, the command interface 306 is implemented as an “omnibox” field—the one incorporating functionality of the field for entering URLs and the field for entering search queries for the search engine to search. In other words, within the depicted embodiment, the user can use the command interface 306 for both entering search queries and URLs. The browsing interface 308 is for displaying to the user either (i) a web resource associated with the URL entered into the command interface 306 or (ii) a search results page (SERP) generated in response to the search query entered in the command interface 306.

The browser application 204 also comprises a control panel 310, the control panel 310 having shortcuts and/or notifications from a number of services. Within the specific example, the services include Yandex™ weather, Gmail™, United States Patent and Trademarks Office, Java™ software download website, news portal www.lenta.ru, YourTube™, news portal rus.delfi.lv. Within the specific example, the content of the control panel 310 is generated by the browser application 204 based on the recently visited web resources and/or services to which the user is logged into (or otherwise is authenticated with). It should be noted that the control panel 310 can be generated in any other manner, can be customized by the user or can be omitted altogether without affecting the scope of implementations of the embodiments of the present technology.

Briefly to complete the description of the browser application 204 of FIG. 3, the browser application 204 comprises a browser control buttons panel 312. The browser control buttons panel 312 includes the well-known button for minimizing the browser screen, maximizing the browser screen and closing the browser screen (all not numbered).

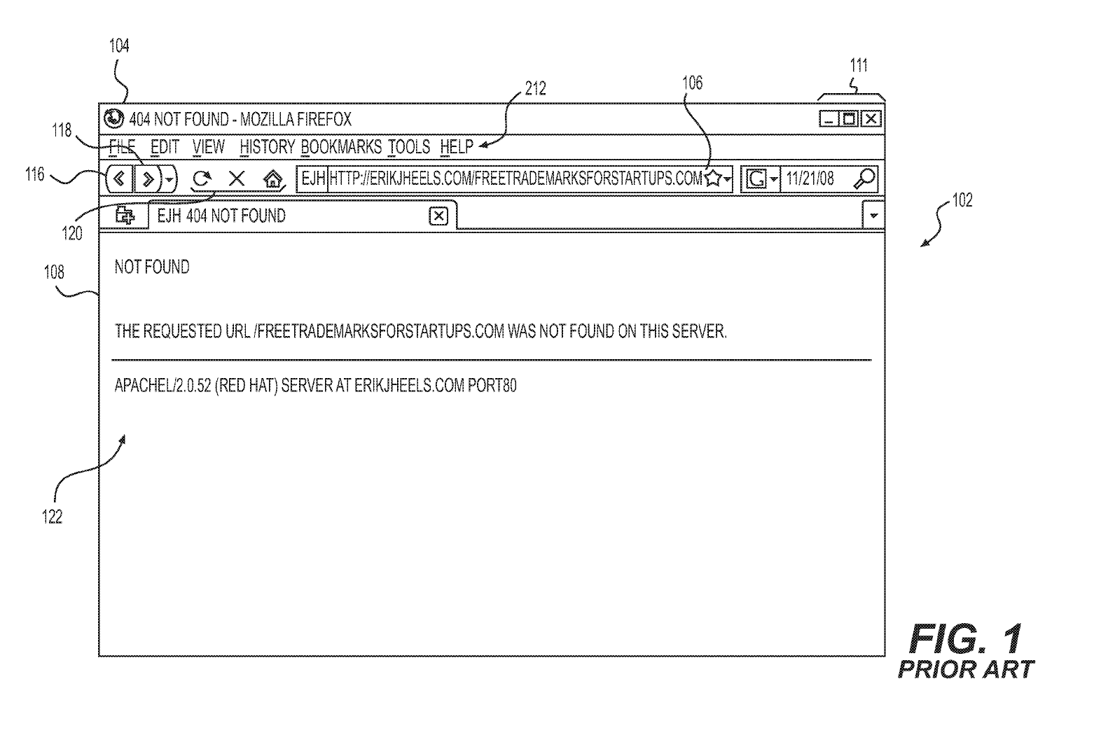

The browser application 204 also includes a conventionally-known back button 314, the back button 314 for allowing the user to go back to previously viewed web resources. It should be expressly noted that the various details of the implementation of the browser application 204 can be varied or omitted without affecting the scope of implementation of the embodiments of the present technology. It should be also expressly understood that embodiments of the present technology are not limited to the browser environment depicted with the illustration of the browser application 204. Teachings presented herein can be equally applied to the browser application 104 of the prior art (FIG. 1) or any other commercially available or proprietary browsers.

Returning to the description of FIG. 2, the electronic device 202 is coupled to a communications network 214 via a communication link 212. In some non-limiting embodiments of the present technology, the communications network 214 can be implemented as the Internet. In other embodiments of the present technology, the communications network 214 can be implemented differently, such as any wide-area communications network, local-area communications network, a private communications network and the like.

How the communication link 212 is implemented is not particularly limited and will depend on how the electronic device 202 is implemented. Recalling that the electronic device 202 is implemented, in this example, as a laptop, the communication link 212 can be either wireless (such as the Wireless Fidelity, or WiFi® for short, Bluetooth® or the like) or wired (such as an Ethernet based connection).

It should be expressly understood that implementations for the electronic device 202, the communication link 212 and the communications network 214 are provided for illustration purposes only. As such, those skilled in the art will easily appreciate other specific implementational details for the electronic device 202, the communication link 212 and the communications network 214. As such, by no means, examples provided herein above are meant to limit the scope of the present technology.

Also coupled to the communications network is a server 216. The server 216 can be implemented as a conventional computer server. In an example of an embodiment of the present technology, the server 216 can be implemented as a Dell™ PowerEdge™ Server running the Microsoft™ Windows Server™ operating system. Needless to say, the server 216 can be implemented in any other suitable hardware and/or software and/or firmware or a combination thereof. In the depicted non-limiting embodiment of present technology, the server 216 is a single server. In alternative non-limiting embodiments of the present technology, the functionality of the server 216 may be distributed and may be implemented via multiple servers.

The implementation of the server 216 is well known. However, briefly speaking, the server 216 comprises a communication interface (not depicted) structured and configured to communicate with various entities via the communications network 214. The server 216 further comprises at least one computer processor (not depicted) operationally connected with the communication interface and structured and configured to execute various processes to be described herein.

In some embodiments of the present technology, the server 216 can be operated by an operator of a search engine, such as the operator of the Yandex™ search engine available at www.yandex.ru. In alternative embodiments, the server 216 can be operated by any other suitable entity, such as another search engine operator and the like.

In alternative embodiments, the server 216 can be operated by the same entity that has provided the afore-described browser application 204. In alternative embodiments, the server 216 can be operated by an entity different from the one who has provided the afore-mentioned browser application 204.

There is further provided a web server 218 also communicatively coupled to the communications network 214. The web server 218 can be implemented as a conventional computer server. In some embodiments of the present technology, the web server 218 can also be implemented as a Dell™ PowerEdge™ Server running the Microsoft™ Windows Server™ operating system. Needless to say, it does not need to be so in every embodiment that the server 216 and the web server 218 are implemented in the same hardware and/or software and/or firmware. The web server 218 can be implemented in any other suitable hardware and/or software and/or firmware or a combination thereof.

The web server 218 comprises hardware, software or firmware (or a combination thereof) to (i) execute a two-way communication with the communications network 214; (ii) to host a web resource 220. In other words, the web server 218 can be configured to store information necessary to cause, via the communications network 214, a client device (such as the electronic device 202) to display a representation of a portion of the web resource 220 in the browsing interface 308 upon the user entering a URL associated with the web resource 220 into the command interface 306 or otherwise activating a link to the web resource 220.

Even though in the depicted non-limiting embodiment of present technology, the server 216 is depicted as a single server, in alternative non-limiting embodiments of the present technology, the there may be present a number of web servers similar to or different from the web server 218. Each one of the non-depicted web servers can be responsible for storing web resources similar to the web resource 220.

For the purposes of the description to be presented herein below, we shall assume that the web resource 220 is not accessible (for whatever reason), resulting in an error message being generated by the web server 218 in response to the electronic device 202 attempting to access the web resource 220. Just for the purposes of the illustration to be presented herein below, let it be assumed that the inaccessibility of the web resource 220 results in the web server 218 generating a “404: Not Found” error message described herein above. It should be expressly understood that the type of the error messages should not be so limited for other embodiments of the present technology. Also, as an illustration only, let it be assumed that the URL associated with the web resource 220 is a web resource hosted on the www.apple.com domain.

Recalling that the user can interact with the browser application 204, let it be assumed that the user has entered the URL associated with the web resource 220 into the command interface 306 of the browser application 204. Responsive to the user entering the URL, the electronic device 202 attempts to access the web resource 220 by sending an access request 280 to the web server 218 via the communications network 214. Recalling that in this example, the web resource 220 is not available, the web server 218 responds by sending an error message 282 to the electronic device 202, the error message 282 containing the “404 Not Found” error message, as an example only.

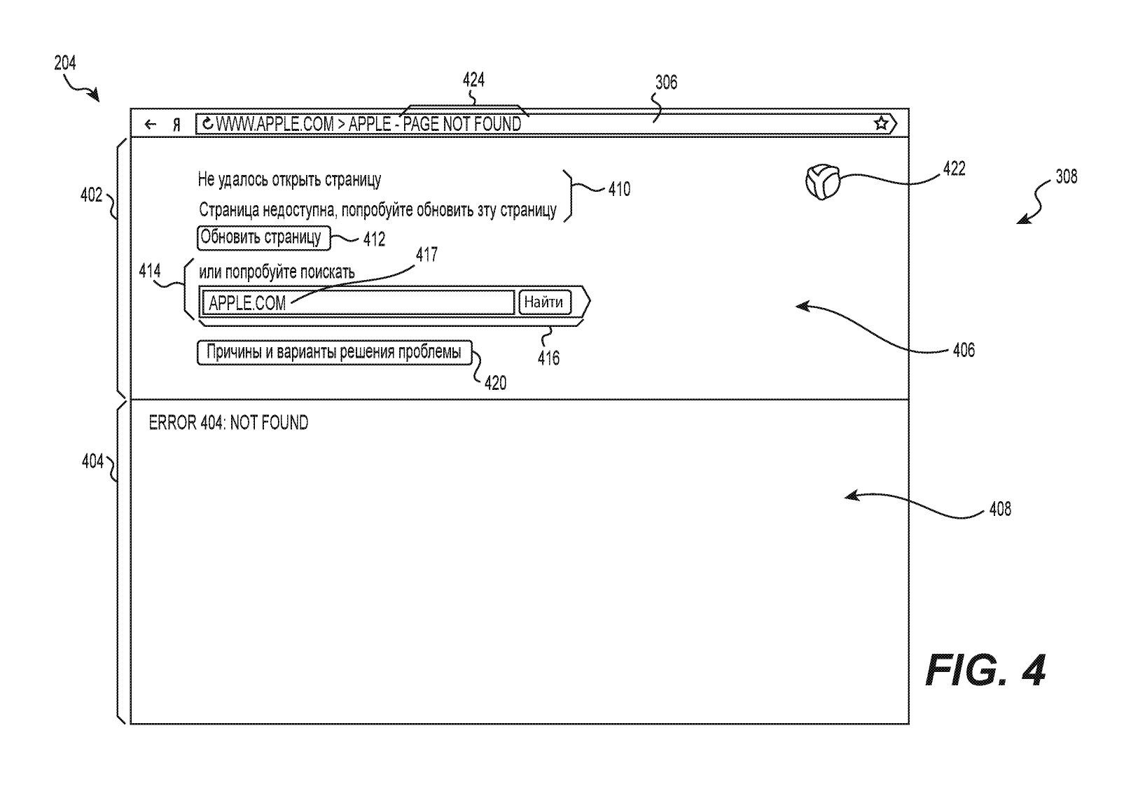

Responsive to the receipt of the error message 282, the browser application 204 executes an error management routine in accordance with embodiments of the present technology. More specifically and using FIG. 4 as an example, the FIG. 4 depicting a portion of the browser application 204 executing the error management routine. More specifically, shown in FIG. 4 are the command interface 306 and the browsing interface 308. The browsing interface 308 has been split into two portions: (i) a first portion 402 depicting a first error resolution field 406 provided by a first source, and (ii) a second portion 404 depicting a second resolution field 408 provided by a second source.

Within the illustrated embodiment, the first source is the browser application 204 itself and the second source is the web server 218, these just being examples of the implementation of the first source and the second source. Broadly speaking, the second source can be the web server 218 (i.e. an entity responsible for the web resource 220) and the first entity is an entity other than the web server (i.e. an entity other than the entity responsive for the web resource 220).

Within the depicted embodiment, the second error resolution field 408 has been generated based on the information provided by the web server 218 and contains an information snippet: “Error 404: NOT FOUND”.

The first error resolution field 408 has been generated based on the information provided by the browser application 204. In the depicted embodiment, the first error resolution field 408 contains an information portion 410, the information portion 410 advising the user that the page is not accessible and the nature of the accessibility error (In Russian: “He [symbol] [symbol] [symbol] . [symbol] [symbol] [symbol] [symbol] [symbol] ”. In English: “The page is not available. The page is not accessible, try to refresh”).

The first error resolution field 408 further contains a page refresh button 412, the page refresh button 412 for refreshing the browser application 204. There is also provided an additional error resolution field 414, the additional error resolution field 414 being implemented as a search bar 416 with a search term 417 suggested therein. The search bar 416 is for enabling the user to execute a search, the search term 417 having been generated by the browser application 204 (or received from the server 216), the search term 417 being somewhat related to the web resource 220 that the user is attempting to access. In the specific example being presented herein, the search term 417 comprises a domain name associated with the domain on the web server 218 hosting the web resource 220.

There is also provided an additional information button 420, the additional information button 420 for enabling the user to request additional information on the type of class of errors experienced and potential additional error resolution approaches. The additional information button 420 depicts in Russian: “ [symbol] [symbol] [symbol] [symbol] ”, or in English: “Error description and solution choices”.

There can also be provided a logo field 422, the logo field 422 containing a logo associated with the provider of the browser application 204.

As an optional enhancement, in some embodiments of the present technology, the command interface 306 has also been augmented with an error message 424, saying “Page Not Found”.

To sum up the depiction of FIG. 4, there is provided by the browser application 204, in response to the receipt of the error message 282: (i) the first portion 402 depicting the first error resolution field 406 provided by the browser application 204, and (ii) the second portion 404 depicting the second resolution field 408 provided by the web server 218, the web server 218 being the host of the web resource 220 being accessed. It is noted that both the first error resolution field 406 and the second error resolution field 408 provide information to the user, the information being helpful in resolving or otherwise dealing with the error situation associated with accessing the web resource 220.

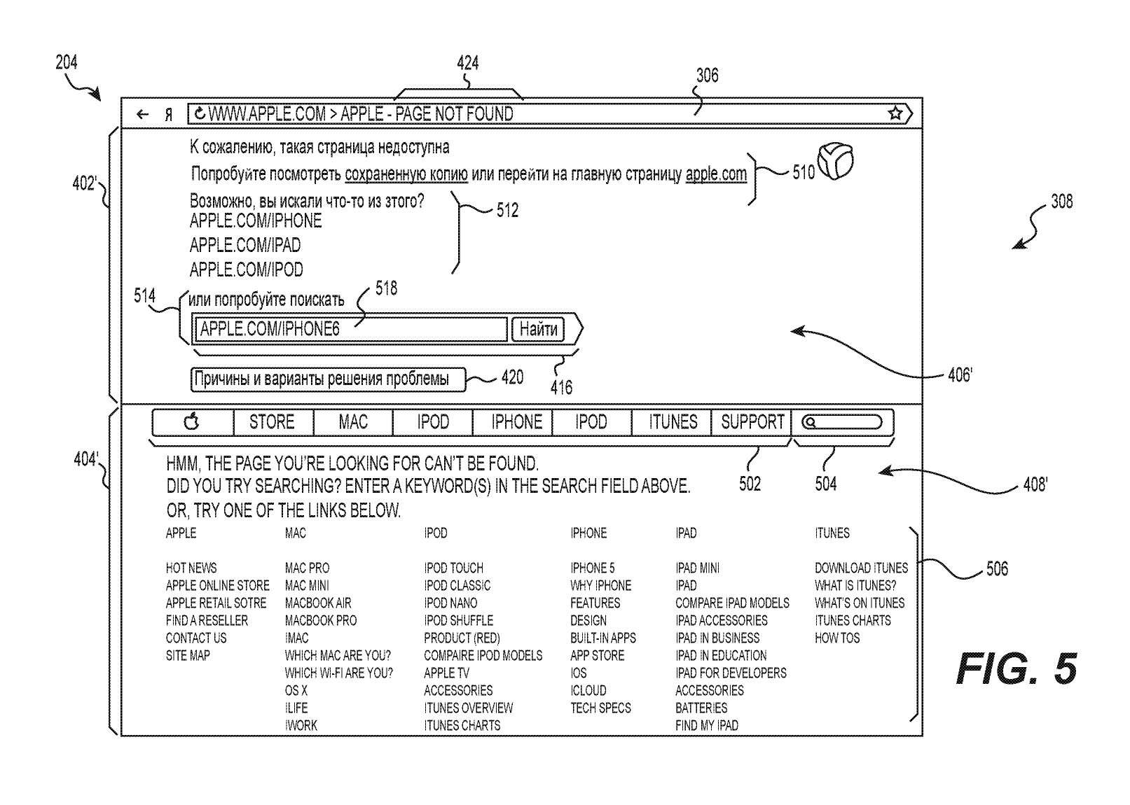

It is noted that in the depicted embodiment, the second error resolution field 406 provides only limited information at best suitable for the user to comprehend the situation with the error message. This embodiment depicted in FIG. 4 particularly suitable to those web resources 220 where the web server 218 has not provided any special or custom messages associated with error messages. An alternative scenario is depicted with reference to FIG. 5, which FIG. 5 depicts a portion of the browser application 204 executing the error management routine implemented in accordance with other embodiments of the present technology.

The command interface 306 and the browsing interface 308 is implemented substantially similar to those of FIG. 4. The browsing interface 308 has been split into two portions: (i) a first portion 402′ depicting a first error resolution field 406′ provided by a first source, and (ii) a second portion 404′ depicting a second resolution field 408′ provided by a second source. Within the illustrated embodiment, the first source is the browser application 204 itself and the second source is the web server 218, these just being examples of the implementation of the first source and the second source.

Within the depicted embodiment, the second error resolution field 408′ has been generated based on the information provided by the web server 218, however in this embodiment, the second error resolution field 408′ contains information which is much more elaborate than that contained in the second error resolution field 408 of FIG. 4.

More specifically, the second error resolution field 408′ comprises a first set of links 502, the first set of links 502 providing a number of links to the web resources similar to the web resource 220 hosted by the web server 218. The second error resolution field 408′ further includes a search field 504, the search field 504 for allowing the user to execute a search of web resources available at the web server 218 and hosted on the same domain as the web resource 220.

The second resolution field 408′ further includes a list of additional links 506, the list of additional links 506 providing a list of links to various resources available at the web server 218 and hosted on the same domain as the web resource 220. Within the specific embodiment of the present technology, the links within the list of additional links 506 are organized into categories. It should be recalled that the content of the second error resolution field 408′ has been generated based on the information from the web server 218 and, as such, in a sense is controlled by the web server 218. In some embodiments, the information required for generation of the second error resolution field 408′ is transmitted from the web server 218 as part of the aforementioned error message 282 or a separate message (not depicted).

The second error resolution field 408′ is also implemented somewhat differently in these embodiments of the present technology as compared to the embodiments of FIG. 4. It should be recalled that the second error resolution field 408′ has been generated based on the information provided by the browser application 204.

In the depicted embodiment, the second error resolution field 408′ contains an information portion 510, the information portion 510 advising the user that the web resource is not accessible and the nature of the accessibility error (In Russian: “ [symbol] [symbol] , [symbol] [symbol] [symbol] [symbol] [symbol] [symbol] [symbol] [symbol] [symbol] [symbol] apple.com”. In English: “Unfortunately, this page is unavailable. Please try to access a cached copy or click this link for the home page of apple.com”). It is noted that in this embodiment, the information portion 510 contains links to the cashed version of the web resource 220 and the home page of the domain associated with the web resource 220.

The second error resolution field 408′ further contains a list of suggested links 512, the list of suggested links 512 containing a number of links to resources related to the web resource 212. The candidates (i.e. the links) generated for the list of suggested links 512 can be generated by the browser application 204 or by the server 116, based on as an example, user past browsing experience, other users' past browsing experience and the like. In some embodiments of the present technology, the candidates for the list of suggested links is generated from a list of verified links, i.e. the links that have been verified by the server 116 to work (to ensure that the user does not get another error message by clicking on one of the list of suggested links 512).

In some embodiments, the candidates for the list of the suggested links 512 is generated by the links correction routine (not depicted). Within these embodiments, the links correction routine can be executed at the electronic device 202 or at the server 216. The links correction routine can be configured to (i) examine the URL entered by the user into the command interface 306; (ii) to identify one or more errors within the URL entered by the user into the command interface 306 or obtained from a link (be it in the host name, the path name or the extension of the URL) and (iii) to identify one or more possible corrections to the URL entered by the user into the command interface 306. In these embodiments, the candidates for the list of the suggested links 512 are generated using the output of the links correction routine.

There is also provided an additional error resolution field 514, the additional error resolution field 514 being implemented similarly to the one in FIG. 4, other than for the search bar 416 having the search term 517 suggested therein being different from the search term 417 of FIG. 4.

There is also provided the additional information button 420 akin to the one of FIG. 4. As an optional enhancement and similar to the embodiment of FIG. 4, in some embodiments of the present technology, the command interface 306 has also been augmented with the error message 424, saying “Page Not Found”.

To sum up the depiction of FIG. 5, there is provided by the browser application 204, in response to the receipt of the error message 282: (i) the first portion 402′ depicting the first error resolution field 406′ provided by the browser application 204, and (ii) the second portion 404′ depicting the second resolution field 408′ provided by the web server 218, the web server 218 being the host of the web resource 220 being accessed. It is noted that both the first error resolution field 406′ and the second error resolution field 408′ provide information to the user, the information being helpful in resolving or otherwise dealing with the error situation associated with accessing the web resource 220.

It is further noted that in the depicted embodiment, the second error resolution field 408′ provides several additional options for dealing with the error situation. Some of these options may be similar to the ones provided in the first error resolution field 406′ and some may be different. This embodiment depicted in FIG. 5 is particularly suitable to those web resources 220 where the web server 218 has provided a special or custom message associated with error messages.

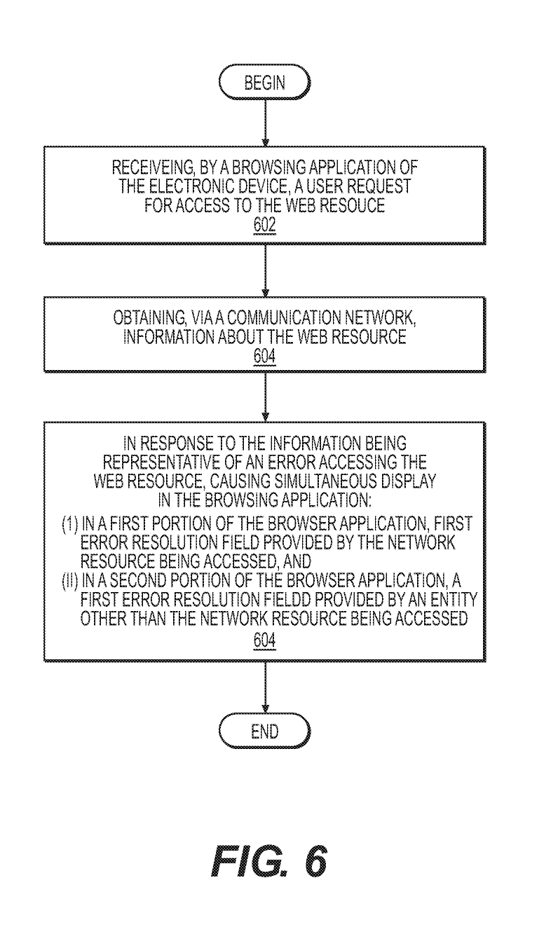

Given the system 200 described above, it is possible to execute a method for managing a user request for an access to a web resource. With reference to FIG. 6, there is depicted a block diagram of a method 600, the method 600 being executables at the electronic device 202. To that end, the electronic device 202 can have a non-transient computer readable medium that contains computer executable instructions, which instructions when executed cause the electronic device 202 to execute the steps of the method 600.

Step 602—receiving, by a browsing application of the electronic device, a user request for access to the web resource

Method 600 starts at step 602, where the browsing application 204 of the electronic device 202 receives a user request for access to the web resource 220. As has been previously alluded to, the user can input her request using the command interface 306 or by clicking a link, just as two examples.

The method 600 then proceeds to execution of step 604.

Step 604—obtaining, via a communication network, information about the web resource

Next, at step 604, the browsing application 204 obtains information about the web resource 220 that the user is trying to access as part of step 602. As an example, the browsing application 204 transmits the access request 280 to the web server 218. It is generally known how the browsing application 204 determines how to reach the web server 218 via the communications network 214 (through the DNS resolution of the URL or the like) and, as such, it will not be described here at any length.

In response, to the transmission of the access request, the browsing application 204 receives information about the web resource 220 that the user is attempting to access.

The method then proceeds to step 606.

Step 606—in response to the information being representative of an error accessing the web resource, causing simultaneous display in the browsing application: (i) in a first portion of the browser, a first error resolution field provided by the network resource being accessed, and (ii) in a second portion of the browser, a second error resolution field provided by an entity other than the network resource being accessed

Next, at step 606, the browser application 204, in response to the information being representative of an error accessing the web resource 220, causes simultaneous display in the browsing application: (i) in a first portion of the browser, a first error resolution field provided by the network resource being accessed, and (ii) in a second portion of the browser, a second error resolution field provided by an entity other than the network resource being accessed.

First, the browser application 204 analyzes the information received from the web server 218. Recalling that in this example, the browsing application 204 receives the error message 282, the browsing application 204 determines that the information receives is indeed representative of an error accessing the web resource 220 that the user is attempting to access. Hence, the browser application 204 causes the electronic device 202 to amend the display of the browsing application 204 according to one of the error management routines described above. It should be understood that the word “simultaneous” refers to the fact of being presented to the user together on the screen, rather than requiring start of the appearance on the screen at the exact precise same moment.

It should be noted, of course, that should the information about the web resource 220 not be representative of the error accessing the web resource 220 (i.e. in case the web resource 220 is available), execution of the method 600 can be terminated or the method 600 can return to execution of step 602.

It should be noted that even though the method 600 has been described as being executable at the electronic device 202, in alternative embodiments of the present technology, the method for managing user request for access to the web resource 220 can be executed at the server 216, as an example, or even the web server 218. As such, in some embodiments, the server 216 can act as an access (or relay) server for user access requests from the electronic device 202 and the server 216 can execute a method of processing a user request for an access to a web resource using an electronic device. The method can comprises receiving, at a server, from the electronic device via a communication network, the user request for the access to the web resource; obtaining information from the web resource; in response to the information being representative of an error accessing the web resource, causing simultaneous display in a browser application of the electronic device: (i) in a first portion of the browser, a first error resolution field provided by the network resource being accessed, and (ii) in a second portion of the browser, a second error resolution field provided by an entity other than the network resource being accessed.

It should be understood that embodiments of the present technology are applicable to management of other types of error situations. Broadly speaking and without limitation, embodiments of the present technology apply to 4xx type of errors, 5xx types of errors, DNS s-type errors, security warning situations and the like.

Also, it should be noted that the specific information provided within the first error resolution field 406, 406′ or the second error resolution field 408, 408′ is not limited to the specific examples provided herein.

Just as an example, what follows are some alternatives for the information that can be provided as part of the first error resolution field 406, 406′.

The first error resolution field 406, 406′ may contain: “Unfortunately, this page is not found. Click here to access a cached copy. Alternatively, click one of the links provided below. For more technical information, please click here”. Alternatively, the first error resolution field 406, 406′ may contain: “Unfortunately, this page is not found. Click here to access a cached copy. Alternatively, click one of the links provided below. As another alternative, try searching Yandex. For more technical information, please click here”. Alternatively, the first error resolution field 406, 406′ may contain: “Unfortunately, this page is restricted. Click here to access a cached copy. Alternatively, click one of the links provided below. For more technical information, please click here”. Alternatively, the first error resolution field 406, 406′ may contain:

“Unfortunately, this page is not available due a server error. Click here to access a cached copy. Alternatively, click one of the links provided below. For more technical information, please click here”.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of processing a user request for an access to a web resource, the method executable at an electronic device, the method comprising:
receiving, by a browsing application of the electronic device, a user request for access to the web resource;
obtaining, via a communication network, information about the web resource;
in response to the information being representative of an error accessing the web resource, causing simultaneous display in the browsing application:
(i) in a first portion of the browser, a first error resolution field provided by a network resource being accessed, and
(ii) in a second portion of the browser, a second error resolution field provided by the browser application, the second error resolution field comprising data based on the user's past browsing experience stored on the electronic device.

2. (canceled)

3. The method of claim 1, wherein the information about the web resource is embodied in an error message.

4. The method of claim 3, further comprising receiving, via the communications network, the error message.

5. The method of claim 4, wherein the error message further comprises information instrumental for generating the first error resolution field.

6. The method of claim 4, wherein the error message is one of a 4xx error, [[a5xx]] a 5xx error, a DNS-type error and a security warning.

7. The method of claim 4, wherein the error message is a “404 Not Found” error message.

8. The method of claim 1, wherein the second error resolution field comprises information about the error.

9. The method of claim 1, wherein the second error resolution field comprises a link to another resource related to the web resource.

10. The method of claim 1, wherein the second resolution field comprises a set of links to at least two resources, the at least two resources having been generated by a link error correction routine based on analysis of errors contained in an address of the web resources entered by the user.

11. The method of claim 1, wherein the second error resolution field further comprises a link to a cached version of the web resource.

12. The method of claim 1, wherein the second error resolution field further comprises a link to a home page of a domain hosting the web resource.

13. The method of claim 1, wherein the second resolution field comprises a search field for enabling the user to execute a web search.

14. The method of claim 13, further comprising populating a suggested search term for the search field, the suggested search term being related to the web resource.

15. The method of claim 1, further comprising augmenting a command field of the browser application with an indication of the error.

16. The method of claim 1, further comprising receiving from a server associated with the web resource information instrumental in generating the first error resolution field.

17. The method of claim 1, wherein the first error resolution field is generated based on a custom error message information provided by a server associated with the web resource.

18. A method of processing a user request for an access to a web resource using an electronic device, the method comprising:
receiving, at a server, from the electronic device via a communication network, the user request for the access to the web resource;
obtaining information from the web resource;
in response to the information being representative of an error accessing the web resource, causing simultaneous display in a browser application of the electronic device:
(i) in a first portion of the browser, a first error resolution field provided by a network resource being accessed, and
(ii) in a second portion of the browser, a second error resolution field provided by the browser application, the second error resolution field comprising data based on the user's past browsing experience stored on the electronic device.

19. An electronic device comprising:
a user input interface;
a user output interface;
a network communication interface; a processor coupled to the user input interface, the user output interface and the network communication interface, a processor configured to execute a browsing application, the processor is further configured to:
receive via the user input interface, a user request for access to the web resource;
obtaining, via the network communication interface, information about the web resource;
in response to the information being representative of an error accessing the web resource, the processor is further configured to simultaneously display via the user output interface:
(i) in a first portion of the user output interface, a first error resolution field provided by a network resource being accessed, and
(ii) in a second portion of the user output interface, a second error resolution field provided by the browser application, the second error resolution field comprising data based on the user's past browsing experience stored on the electronic device.

20. (canceled)

21. The electronic device of claim 19, wherein the information about the web resource is embodied in an error message.

22. The electronic device of claim 21, wherein the processor is further configured to receive, via the network communication interface, the error message.

23-35. (canceled)
